(19) United States
(12) Patent Application Publication
(10) Pub. No.: US 2007/0140363 A1
(43) Pub. Date: Jun. 21, 2007

(54) Method of link adaptation in MIMO beamforming systems

(75) Inventors: Jyh Chau Horng, Saratoga, CA (US); Chiu Ngo, San Francisco, CA (US)

Correspondence Address: Kenneth L. Sherman, Esq.;Myers Dawes Andras & Sherman, LLP, 11th Floor, 19900 MacArthur Blvd., Irvine, CA, 92612, US

(73) Assignee: Samsung Electronics Co., Ltd., Suwon City (KR)

(21) Appl. No.: 11/313,359

(22) Filed: Dec. 20, 2005

(51) Int. Cl. H04K 1/10

(52) U.S. Cl. 375/260

(57) ABSTRACT

An apparatus and method for closed-loop signaling over multiple channels in a telecommunication system. Channel condition for each channel is obtained, and transmission rate per channel is determined according to channel condition. The information bit streams is transmitted via the multiple channels over a plurality of transmitter antennas according to the transmission rates.

### FIELD OF THE INVENTION

The present invention relates generally to data communication, and more particularly, to data communication in multi-channel communication system such as multiple-input multiple-output (MIMO) systems.

### BACKGROUND OF THE INVENTION

A multiple-input-multiple-output (MIMO) communication system employs multiple transmit antennas in a transmitter and multiple receive antennas in a receiver for data transmission. A MIMO channel formed by the transmit and receive antennas may be decomposed into independent channels, wherein each channel is a spatial sub-channel (or a transmission channel) of the MIMO channel and corresponds to a dimension. The MIMO system can provide improved performance, (e.g., increased transmission capacity) if the additional dimensionalities created by the multiple transmit and receive antennas are utilized.

MIMO techniques are adopted in wireless standards, such as 3GPP, for high data rate services. In a wireless MIMO system, multiple antennas are used in both transmitter and receiver, wherein each transmit antenna can transmit a different data stream into the wireless channels whereby the overall transmission rate is increased.

There are two types of MIMO systems, known as open-loop and closed-loop. In an open-loop MIMO system, the MIMO transmitter has no prior knowledge of the channel condition (i.e., channel state information). As such, space-time coding techniques are usually implemented in the transmitter to prevent fading channels. In a closed-loop system, the channel state information (CSI) can be fed back to the transmitter from the receiver, wherein some pre-processing can be performed at the transmitter in order to separate the transmitted data streams at the receiver side. Such techniques are referred to as beamforming techniques, which provide better performance in desired receiver's directions and suppress the transmit power in other directions.

The SVD (singular value decomposition) type of beamforming technique is widely used in closed-loop MIMO systems. Using SVD, a MIMO channel can be decomposed into several independent channels for data transmission resulting in no interferences between different data streams at the receiver.

Since the MIMO channels can be decomposed into independent channels with different eigenvalues, the transmission rates for each channel can be selected based on the channel eigenvalues, as described in S. A. Mujtaba, “TGn Sync Proposal Technical Specification”, a contribution to IEEE 802.11, 11-04-889r1, November 2004 (incorporated herein by reference).

The algorithm to select the transmission rates can be adapted to the channel conditions (i.e., link adaptation algorithm). However, in a beamforming system with uneven power loadings, the signal-to-noise-ratio (SNR) is also tightly related to the power loadings in all the channels, as shown in D.-S. Shiu, G. J. Fochini, M. J. Gans, and J. M. Kahn, “Fading correlation and its effect on the capacity of multi-element antenna systems”, IEEE Trans. Communication, vol. 48, pp. 502-513, March 2000.

Using the link adaptation algorithm based only on the channel eigenvalues causes significant performance degradations, especially for the beamforming systems supporting even transmission rates for all channels.

### BRIEF SUMMARY OF THE INVENTION

In one embodiment the present invention provides an apparatus and method for closed-loop signaling over multiple channels in a telecommunication system. Channel condition for each channel is obtained, and transmission rate per channel is determined according to channel condition. The information bit streams is transmitted via the multiple channels over a plurality of transmitter antennas according to the transmission rates.

In order to increase system capacity, a link adaptation algorithm according to the present invention is utilized in selecting channel transmission rates. According to an embodiment of the present invention, a method to determine the transmission rates for each channel in a beamforming system selects the transmission rates based on the channel conditions (i.e., link adaptation algorithm).

The present invention further provides a general criterion for determining the SNR for transmission rate selections in a beamforming MIMO system. For a beamforming MIMO system with uneven power loading, the present invention provides better link adaptation quality than transmission rate selections based on channel eigenvalues. For a beamforming system supporting even transmission rates for all channels, the present invention together with uneven power loadings provides significant performance improvements over the prior art.

These and other features, aspects and advantages of the present invention will become understood with reference to the following description, appended claims and accompanying figures.

### BRIEF DESCRIPTION OF THE DRAWINGS

FIG. 1 shows a functional block diagram of a SVD MIMO system implementing Link Adaptation according to an embodiment of the present invention.

FIG. 2 shows a flowchart of example steps of rate selection algorithm according to an embodiment of the present invention.

FIG. 3 shows a flowchart of example steps of beamforming systems supporting even transmission rate according to another embodiment of the present invention.

### DETAILED DESCRIPTION OF THE INVENTION

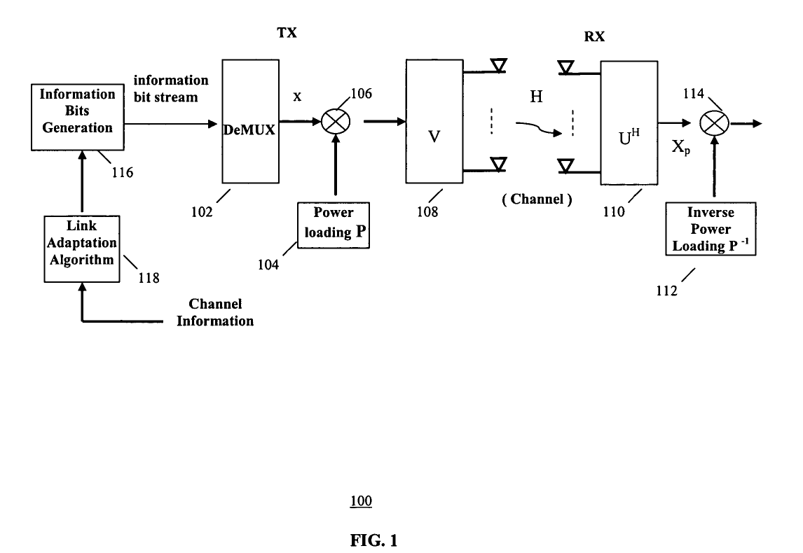

FIG. 1 shows an example block diagram of a MIMO system 100 including beamforming, according to an embodiment of the present invention. The MIMO system 100 in FIG. 1 includes a transmitter TX comprising a demultiplexer DeMUX 102, a power loading unit 104 that implements power control for each transmitter antenna, a Combiner 106 and a V processing function 108. The demultiplexer DeMUX 102 splits the incoming information bits into Nₛₛ streams. Each data stream is multiplied in the Combiner 106 by the respective power loading P which is provided by the power loading unit 104. The MIMO system 100 further includes a receiver RX comprising a U^{H} processing function 110, a P⁻¹ (i.e., inverse of P) function 112 and a combiner 114. The matrix P⁻¹ in function 112 is a Nₛₛ-by-Nₛₛ diagonal matrix with inverse of the power loading P for each stream along the diagonal. The combiner 114 provides a multiplication operation. Further, a bit generator 116 generates information bits and an adaptation unit 118 provides pre-defined look-up table for selecting data rate based on SNR information.

In the MIMO system 100 of FIG. 1, the receiver RX is provided with the power loading information used by the transmitter TX, via the P⁻¹ function 112. Using the power loading information the receiver RX can properly demodulate the received signals. In one example, the transmitter TX provides the power loading information to the receiver RX. In another example, the receiver RX estimates the power loading of the transmitter TX.

The power loading unit 104 of the MIMO system 100 implements adaptive power loading for different transmit channels according to the present invention. In one embodiment, where the SNR thresholds for peak rate transmission are known, the power loading unit 104 performs channel power loading.

For the MIMO system 100 having a channel H with Nₜ transmit antennas and Nᵣ receiving antennas, without V processing at the transmitter TX, the received signal y can be represented as:
y=HPx+n (1)

where x is the Nₜ×1 transmitted signal vector, P is a diagonal matrix with loading power αᵢ along the diagonal, and n is the additive noise in the channel.

The channel H comprises a Nᵣ×Nₜ matrix wherein each element hᵢⱼ of the matrix represents the channel response from j^{th} transmit antenna to i^{th} receiving antenna. By applying SVD to H, H can be expressed as:
H=UDV^{H} (2)

wherein U and V are unitary matrices (i.e., U is a Nᵣ×Nₜ matrix, and V^{H} is a Nₜ×Nₜ matrix), and D is a Nₜ×Nₜ a diagonal matrix with the elements equal to the square-root of eigenvalues of the matrix (HH^{H}), where (•)^{H} is the Hermitian operation.

For simplicity of explanation of the example embodiments of the present invention herein, it is assumed that Nₛₛ=Nₜ. Hence, in the following description, the matrix dimensions are related to Nₜ, not Nₛₛ. As those skilled in the art will recognize, the present invention applies to the generalized case where Nₜ>=Nₛₛ.

As shown in FIG. 1, with V processing at the transmitter TX, relation (1) becomes:
y=HVPx+n (3)

And with U^{H} processing at the receiver RX, the received signal after processing Xₚ can be expressed as:
Xₚ=U^{H}y=DPx+U^{H}n (4)

wherein the transmitted data x can be completely separated after this operation since D and P are diagonal matrices.

The eigenvalues in every channel play important roles in determining the signal-to-noise ratios (SNR), which is commonly used for transmission rate selections. Since the MIMO channels can be decomposed into independent channels with different eigenvalues, the transmission rates for each channel can be selected based on the channel eigenvalues, as described in S. A. Mujtaba, “TGn Sync Proposal Technical Specification”, a contribution to IEEE 802.11, 11-04-889r1, November 2004.

The algorithm to select the transmission rates can be adapted to the channel conditions (link adaptation algorithm). However, in a beamforming system with uneven power loadings, the SNR is also tightly related to the power loadings in all the channels, as shown in the reference D.-S. Shiu, G. J. Fochini, M. J. Gans, and J. M. Kahn, “Fading correlation and its effect on the capacity of multi-element antenna systems”, IEEE Trans. Communication, vol. 48, pp. 502-513, March 2000. It can be shown that in said reference, the capacity for a beamforming system can be expressed as the sum of multiple AWGN (additive white Gaussian noise) channels by:

$$C = {\sum }_{i = 1}^{{N}_{t}} log ( 1 + \frac{{λ}_{i} {p}_{i}^{2}}{{N}_{0}} ) \qquad ( 5 )$$

where λᵢ and pᵢ² are the eigenvalue and transmitted power corresponding to the decomposed channels, respectively, and N₀ is the noise power.

From relation (5) above, it is observed that the transmitted power plays an important role in determining the system capacity, since other parameters, λᵢ and N₀, are related to channel conditions and cannot be controlled. In fact, the signal to noise ratio for each channel is linearly proportional to the product of power loadings and channel eigenvalues. From relation (4) and (5), the SNR for each channel, SNRᵢ, can be expressed as:

$${SNR}_{i} = \frac{{λ}_{i} {P}_{i}}{{N}_{0}} \qquad ( 6 )$$

where we assume the total transmitted power is fixed, i.e.,

$${\sum }_{i = 1}^{{N}_{t}} {p}_{i}^{2} = {P}_{total} \qquad ( 7 )$$

Under the assumption that, before the power scaling operation, the power for each data stream, P_{data}, is identity, the power loading αᵢ, can be shown by:

$${α}_{i}^{2} = \frac{{p}_{i}^{2}}{{P}_{data}} = {p}_{i}^{2} \qquad ( 8 )$$

Therefore, the criterion for transmission rate selection should be determined by the product of power loading and channel eigenvalue, since the SNR for ith channel can be expressed as:

$${SNR}_{i} = \frac{{λ}_{i} {α}_{i}}{{N}_{0}} \qquad ( 9 )$$

The procedure of rate selection according to the present invention includes the steps of:
Step 1: Calculate the product (λᵢαᵢ), representing the adjusted signal power, according to channel conditions.
Step 2: Calculate the corresponding SNR for each channel based on relation (9).
Step 3: From a pre-defined table select the transmission rate Rᵢ based on the calculated SNR in step 2. The pre-defined table is based on the measurements and system testing results, defining the required SNRs to support certain transmission rates.
Step 4: Repeat steps 1-3 for all the channels.

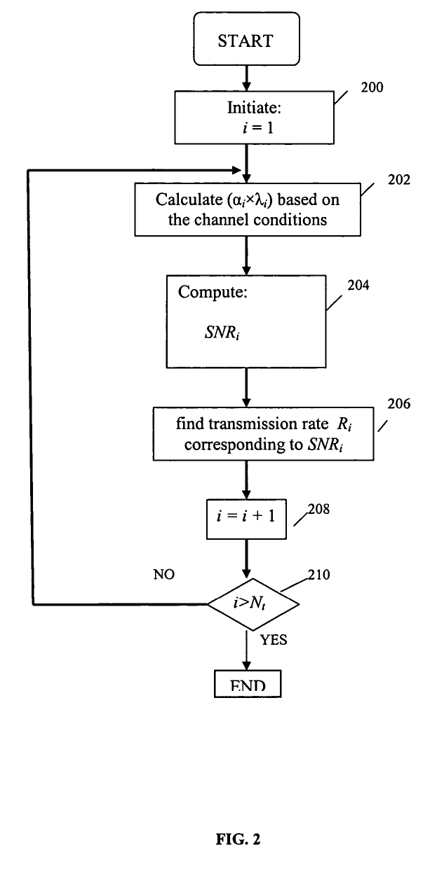

FIG. 2 shows a flowchart of an example implementation of the above steps of rate selection procedure according to the present invention. The example implementation includes the steps of:
Initiate index i=1 (step 200);
Calculate (αᵢλᵢ) based on the channel conditions (step 202);
Compute SNRᵢ according to relation (9) above (step 204);
Find transmission rate Rᵢ corresponding to SNRᵢ (step 206);
Increment index i by one (step 208);
Determine if transmission rate for all channels been calculated: i>Nₜ? (step 210);
If not, then proceed to step 202 to determine transmission rate for remaining channels, otherwise terminate the process.

The selection of Rᵢ is a direct mapping from a pre-defined table. Based on the measurements and system testing results, this table defines the required SNRs to support certain transmission rates. Once the SNR is estimated, the corresponding transmission rate from the table may be selected.

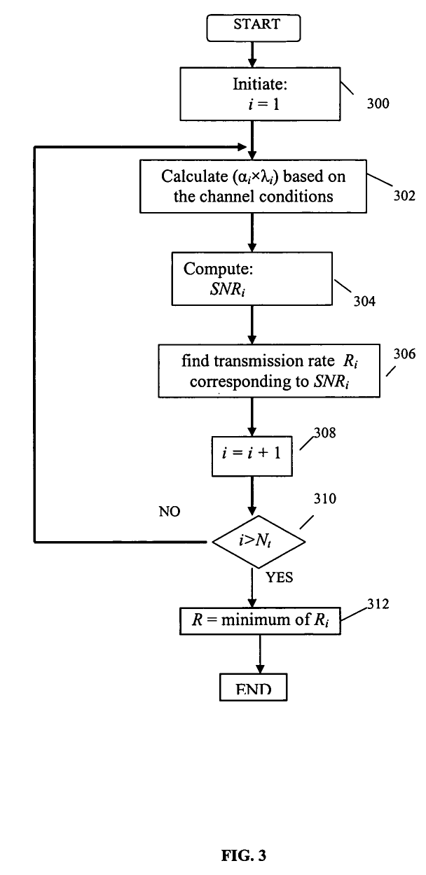

In general, the transmission rate is changed by changing the modulation scheme and coding rate for the transmitted data. In case of beamforming systems supporting even transmission rate for all the channels, the rate selection procedure can include the steps of: (i) finding the transmission rate in each channel Rᵢ from steps 1-4 above, and (ii) select final rate R=minimum of Rᵢ. FIG. 3 shows a flowchart of the steps of an example implementation of the case of even transmission rates, including the steps of:
Initiate index i=1 (step 300);
Calculate (αᵢ×λᵢ) based on the channel conditions (step 302);
Compute SNRᵢ according to relation (9) (step 304);
Find transmission rate Ri corresponding to SNRᵢ (step 306);
Increment index i by one (step 308);
Determine if transmission rate for all channels been calculated: i.e., i>Nₜ? (step 210);
If not, then proceed to step 302 to determine transmission rate for remaining channels, otherwise R=minimum of Rᵢ (step 312).

In another embodiment, the link adaptation/rate selection may be implemented at the receiver RX (FIG. 1). In such a case, the receiver RX uses the above algorithms to perform transmission rate selection and then feedback to the transmitter TX through the uplink signaling channels. Based on the recommended rate sent by the receiver RX, the transmitter TX makes final decisions on the rate selection.

The present invention provides a general criterion in determining the SNR for transmission rate selections in a beamforming system. For a beamforming system with uneven power loading, the present invention provides better link adaptation quality than the algorithm based on channel eigenvalues. For a beamforming system supporting even transmission rates for all channels, the present invention together with uneven power loadings has significant performance improvements over the prior art systems.

As those skilled in the art recognize, the embodiments described herein are examples of generalized case of Nₜ>Nₛₛ where in that case, x is Nₛₛ×1, P is Nₛₛ×Nₛₛ, V is Nₜ×Nₛₛ, U^{H} is Nₛₛ×Nᵣ, etc., according to the present invention.

The present invention has been described in considerable detail with reference to certain preferred versions thereof; however, other versions are possible. Therefore, the spirit and scope of the appended claims should not be limited to the description of the preferred versions contained herein.

What is claimed is:

1. A telecommunication system, comprising:
a wireless transmitter that transmits data streams via multiple channels over a plurality of antennas to a receiver, the system including a controller that selects transmission rate per channel according to the channel condition.

2. The system of claim 1 wherein the transmitter is a MIMO transmitter.

3. The system of claim 1 wherein the controller obtains channel condition for each channel, and selects channel transmission rates as a function of the channel conditions using a link adaptation process.

4. The system of claim 1 wherein the transmitter transmits an information bit stream via said multiple channels over a plurality of transmitter antennas according to the corresponding transmission rates.

5. The system of claim 3 wherein the controller selects channel transmission rate for each channel by:
calculating an adjusted signal power as a function of the power loading and the channel eigenvalue;
calculating the SNR for the channel as a function of said adjusted signal power; and
selecting the transmission rate based on the calculated SNR.

6. The system of claim 5 wherein the adjusted signal power is a product of the power loading α and the channel eigenvalue λ.

7. The system of claim 5 wherein controller calculates the SNR as a ratio of said adjusted signal power and noise power N₀.

8. The system of claim 5 wherein the controller selects the transmission rate from a pre-defined table based on the calculated SNR.

9. The system of claim 3 further including power loading unit that determines transmission power loading per channel according to channel condition.

10. The system of claim 9 wherein the power loading unit selects uneven power loading among the multiple channels.

11. The system of claim 5 further including a power loading unit that selects even power loading among the multiple channels, wherein the controller selects a final transmission rate for each channel to be the minimum of said calculated transmission rates for the multiple channels.

12. The system of claim 3 wherein controller obtains the channel condition by determining the eigenvalue for each channel.

13. The system of claim 3 wherein the receiver demodulates the received bit streams based on transmission rates of the transmitter.

14. The system of claim 3 wherein the controller is a component of the transmitter.

15. The system of claim 3 wherein the controller is a component of the receiver, wherein the receiver determines the transmission rates and provides the transmission rates to the transmitter.

16. The system of claim 15 wherein the wireless transmitter comprises an orthogonal frequency division multiplexing (OFDM) transmitter.

17. A closed-loop signaling method over multiple channels in a telecommunication system, comprising the steps of:
obtaining an information bit stream;
obtaining channel condition for each channel;
selecting channel transmission rates as a function of the channel conditions using a link adaptation process; and
transmitting the information bit stream via said multiple channels over a plurality of transmitter antennas according to the corresponding transmission rate.

18. The method of claim 17 wherein the transmitter comprises a MIMO transmitter.

19. The method of claim 17 wherein the step of selecting channel transmission rate for each channel further includes the steps of:
calculating an adjusted signal power as a function of the power loading and the channel eigenvalue;
calculating the SNR for the channel as a function of said adjusted signal power;
selecting the transmission rate based on the calculated SNR.

20. The method of claim 19 wherein the adjusted signal power is a product of the power loading α and the channel eigenvalue λ.

21. The method of claim 20 wherein the step of calculating the SNR further includes calculating the SNR as a ratio of said adjusted signal power and noise power N₀.

22. The method of claim 19 wherein the step of selecting the transmission rate further includes the steps of selecting the transmission rate from a pre-defined table based on the calculated SNR.

23. The method of claim 19 further including the steps of determining transmission power loading per channel according to channel condition.

24. The method of claim 19 further including the steps of selecting uneven power loading among the multiple channels.

25. The method of claim 19 further including the steps of:
selecting even power loading among the multiple channels; and
selecting the final transmission of each channel to be the minimum of said calculated transmission rates for the multiple channels.

26. The method of claim 17 wherein the step of obtaining channel condition further includes the steps of determining the eigenvalue for each channel.

27. The method of claim 17 further comprising the steps of:
receiving the transmitted bits streams in a receiver; and
demodulating the received bit streams based on transmission rates of the transmitter.

28. The method of claim 17 wherein the system includes a transmitter and receiver, wherein the transmitter determines the transmission rates.

29. The method of claim 17 wherein the system includes a transmitter and receiver, wherein the receiver determines the transmission rates and provides the transmission rates to the transmitter.

30. The method of claim 17 wherein the telecommunication system operates on a multi-carrier basis, further including the steps of selecting transmission rate per channel on a sub-carrier basis.

31. The method of claim 17 wherein telecommunication system comprises a wireless comprises an orthogonal frequency division multiplexing (OFDM) system.
